(19) United States
(12) Patent Application Publication
(10) Pub. No.: US 2026/0361078 A1
(43) Pub. Date: Nov. 12, 2026

(54) MULTIMODE POWER SUPPLY APPARATUS AND MULTIMODE POWER SUPPLY METHOD

(71) Applicant: SENAO NETWORKS, INC., Taoyuan (TW)

(72) Inventor: Pi-Kuang KU, TAOYUAN (TW)

(21) Appl. No.: 19/544,147

(22) Filed: Feb. 19, 2026

(30) Foreign Application Priority Data
May 6, 2025 (TW) 114116953

(51) Int. Cl. H02J 1/12; H02J 1/10; H02J 7/00; H02J 7/44

(52) U.S. Cl. CPC H02J 1/12; H02J 1/106; H02J 7/44; H02J 7/855

(57) ABSTRACT

A power supply apparatus comprises an output connector, a control unit, a communication unit and an alternative power supply unit. The communication unit determines, through the output connector, whether a powered device complies with a standard. The control unit is used to: in response to determining that the powered device does not comply with the standard, turn off the electrical coupling between the communication unit and the output connector; turn on the alternative power supply unit and instruct the alternative power supply unit to raise the voltage of the output connector from a default voltage value; when the current of the output connector becomes greater than a threshold value, record the voltage of the output connector as a starting voltage; instruct the alternative power supply unit to set the output connector at the starting voltage times an operation ratio; and monitor the voltage and the current of the output connector.

### CROSS-REFERENCE TO RELATED APPLICATION

This application claims priority to Tiawan Patent Application No. 114116953 filed on May. 6, 2026 , the contents of which are incorporated herein by reference in its entirety.

### FIELD OF INVENTION

The present invention relates generally to power electronics technology, and more particularly to a multimode power supply apparatus and method thereof.

### BACKGROUND

A conventional network power supply system, or sometimes called a power over Ethernet (PoE) system, is mainly divided into two parts: power sourcing equipment (PSE) and powered device (PD). The IEEE 802.3af standard established in 2003 stipulates that PSE can provide about 15 watts of power to PD. As the market demand for higher power increases, the latest IEEE 802.3bt standard has increased the maximum power supply power of PSE to 90 watts to meet more application scenarios. However, there are still some old or low-cost powered devices on the market that are not compatible with the IEEE 802.3 standard family. The power supply requirements of these devices vary, and the corresponding power sourcing equipment are also diverse, which is inconvenient to use and subject to a high risk of equipment damage.

### SUMMARY

The objective of the present invention is to provide a multimode power supply apparatus and method thereof that simultaneously support functions such as standard power supply, non-standard (passive) power supply and battery backup, thereby improving convenience and safety of use.

One aspect of the present invention is directed to a multimode power supply apparatus comprising an output connector, a control unit, a communication unit and an alternative power supply unit. The communication unit is configured to determine, through the output connector, whether the powered device complies with a standard. The control unit is configured to: in response to a determination that the powered device does not comply with the standard, turn off an electrical coupling between the communication unit and the output connector; turn on the alternative power supply unit and instruct the alternative power supply unit to raise a voltage of the output connector from a default voltage value; when a current of the output connector becomes greater than a threshold current value, record the voltage of the output connector as a starting voltage; instruct the alternative power supply unit to set the output connector at the starting voltage multiplied by an operating factor; and monitor the voltage and the current of the output connector.

In some implementations, the control unit is configured to detect whether the output connector receives a surge voltage, and the communication unit is configured to determine whether the powered device complies with the standard in response to the output connector receiving the surge voltage.

In some implementations, the control unit is further configured to: in response to a determination that the powered device complies with the standard, instruct the communication unit to set the output connector at a rated voltage of the powered device; and monitor the voltage and the current of the output connector.

In some implementations, the standard is selected from the IEEE 802.3 standard family.

In some implementations, the default voltage value is 0 volt.

In some implementations, the threshold current value is 0 ampere.

In some implementations, the alternative power supply unit is a DC conversion unit.

In some implementations, an upper limit for the alternative power supply unit to raise the voltage of the output connector from the default voltage value is between 55-60 volts.

In some implementations, the operating factor is between 1-1.2.

In some implementations, the control unit is further configured to upload power supply data to the cloud.

In some implementations, the control unit is further configured to: in response to any one of the following being monitored: (1) the voltage at the output connector has deviated from the set voltage over a threshold time; or (2) the current of the output connector has become less than the threshold current value over the threshold time, turn off the communication unit and the alternative power supply unit, send a warning to reconnect the powered device, and detect whether the output connector receives the surge voltage.

In some implementations, the control unit is further configured to: detect whether a first output of a power source unit is within a first normal range, and/or whether a second output of a battery is within a second normal range; and in response to the first output being within the first normal range or the second output being within the second normal range, detect whether the output connector receives the surge voltage.

In some implementations, the first normal range is 51.3-56.7 Vdc, and the second normal range is 36-52 Vdc.

In some implementations, the power source unit and/or the battery is electrically coupled to the control unit, the communication unit and the alternative power supply unit through a one-way conduction circuit.

In some implementations, the control unit is further configured to: in response to any one of the following being monitored: (1) the voltage of the output connector has deviated from the set voltage over a threshold time; or (2) the current of the output connector has become less than the threshold current value over the threshold time, turn off the communication unit and the alternative power supply unit, send a warning to reconnect the powered device, and detect whether the first output is within the first normal range, and/or whether the second output is within the second normal range.

Another aspect of the present invention is directed to a multimode power supply method comprising: instructing a communication unit to determine, through an output connector, whether a powered device complies with a standard; and in response to the powered device not complying with the standard, turning off an electrical coupling between the communication unit and the output connector; turning on an alternative power supply unit and instructing the alternative power supply unit to raise a voltage of the output connector from a default voltage value; when a current of the output connector becomes greater than a threshold current value, recording the voltage of the output connector as a starting voltage; instructing the alternative power supply unit to set the output connector at the starting voltage times an operation ratio; and monitoring the voltage and the current of the output connector.

In some implementations, the multimode power supply method further comprises: detecting whether the output connector receives a surge voltage, wherein determining whether the powered device complies with the standard is in response to the output connector receiving the surge voltage.

In some implementations, the multimode power supply method further comprises: in response to the powered device complying with the standard, instructing the communication unit to set the output connector at a rated voltage of the powered device; and monitoring the voltage and the current of the output connector.

In some implementations, the standard is selected from the IEEE 802.3 standard family.

In some implementations, the default voltage value is 0 volt.

In some implementations, the threshold current value is 0 ampere.

In some implementations, the alternative power supply unit is a DC conversion unit.

In some implementations, an upper limit for the alternative power supply unit to raise the voltage of the output connector from the default voltage value is between 55-60 volts.

In some implementations, the operation ratio is between 1-1.2.

In some implementations, the multimode power supply method further comprises: uploading power supply data to the cloud.

In some implementations, the multimode power supply method further comprises: in response to any one of the following being monitored: (1) the voltage at the output connector has deviated from the set voltage over a threshold time; or (2) the current of the output connector has become less than the threshold current value over the threshold time, turning off the communication unit and the alternative power supply unit, sending a warning to reconnect the powered device, and detecting whether the output connector receives the surge voltage.

In some implementations, the multimode power supply method further comprises: detecting whether a first output of a power source unit is within a first normal range, and/or whether a second output of a battery is within a second normal range; and in response to the first output being within the first normal range or the second output being within the second normal range, detecting whether the output connector receives the surge voltage.

In some implementations, the first normal range is 51.3-56.7 Vdc, and the second normal range is 36-52 Vdc.

In some implementations, the power source unit and/or the battery is electrically coupled to the control unit, the communication unit and the alternative power supply unit through a one-way conduction circuit.

In some implementations, the multimode power supply method further comprises: in response to any one of the following being monitored: (1) the voltage of the output connector has deviated from the set voltage over a threshold time; or (2) the current of the output connector has become less than the threshold current value over the threshold time, turning off the communication unit and the alternative power supply unit, sending a warning to reconnect the powered device, and detecting whether the first output is within the first normal range, and/or whether the second output is within the second normal range.

### BRIEF DESCRIPTION OF THE DRAWINGS

FIG. 1 is a schematic diagram of a multimode power supply apparatus according to an embodiment of the present invention.

FIG. 2 is a schematic diagram of a multimode power supply apparatus according to a further embodiment of the present invention.

FIG. 3 is a schematic diagram of a multimode power supply apparatus according to another embodiment of the present invention.

FIG. 4 is a schematic diagram of a multimode power supply apparatus and powered device circuit diagram according to at least one embodiment of the present invention.

FIG. 5 is a schematic diagram of operational waveform of an alternative power supply unit according to at least one embodiment of the present invention.

FIGS. 6A and 6B are schematic flowcharts of a multimode power supply method according to at least one embodiment of the present invention.

### DETAILED DESCRIPTION

Features of the present invention are set forth below in connection with the appended drawings. One of ordinary skill in the art may, after understanding embodiments of the present invention, change and modify the techniques taught herein without departing from the spirit and scope of the present invention.

The terms “include”, “comprise”, “have”, “contain”, etc. used herein are open-ended terms that specify the existence of the described features, regions in partial or as a whole, steps, operations, elements and/or parts, but do not exclude the existence or addition of one or more other features, regions in partial or as a whole, steps, operations, elements, parts and/or combinations thereof. That is, they mean including but not limited to.

As used herein, unless the content clearly indicates otherwise, the singular forms “a”, “an” and “the” are intended to include plural forms, including “at least one”. The terms “or” and “and/or” used herein includes any or all combinations of the items described.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning consistent with their meaning in the context of the relevant art and the present invention, and will not be interpreted in an idealized or overly formal sense unless expressly so defined herein.

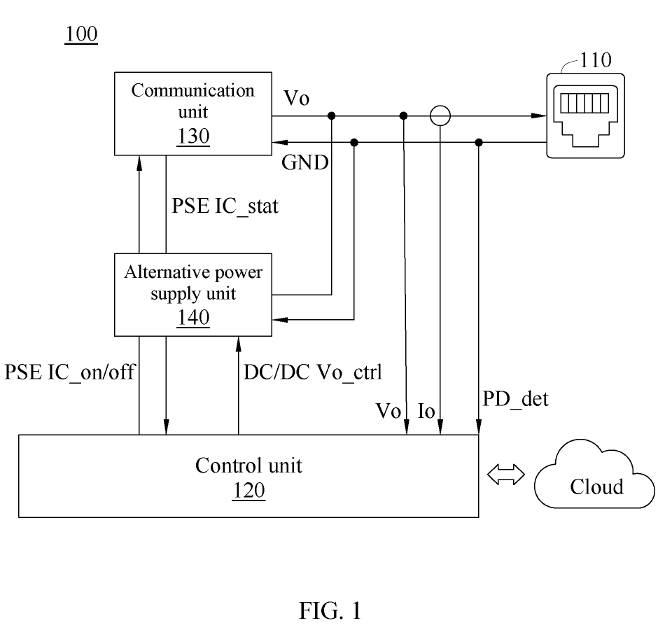

FIG. 1 is a schematic multimode power supply apparatus according to at least one embodiment of the present invention. As shown in FIG. 1, the multimode power supply apparatus 100 may include an output connector 110, a control unit 120, a communication unit 130 and an alternative power supply unit 140. The control unit 120, the communication unit 130 and the alternative power supply unit 140 are electrically coupled to the output connector 110. The output connector 110 may be of RJ45 specification, for example, and may include a ground GND. The control unit 120 may be implemented by a microcontroller, for example, and may optionally upload power supply data to the cloud. The communication unit 130 may be implemented by a communication chip complying with the IEEE 802.3 standard family, for example, and may include pins like PSE IC_on/off, PSE IC_stat, etc. The alternative power supply unit 140 may be implemented by a DC conversion unit such as a DC-DC buck converter, and may include pins like DC/DC Vo_ctrl.

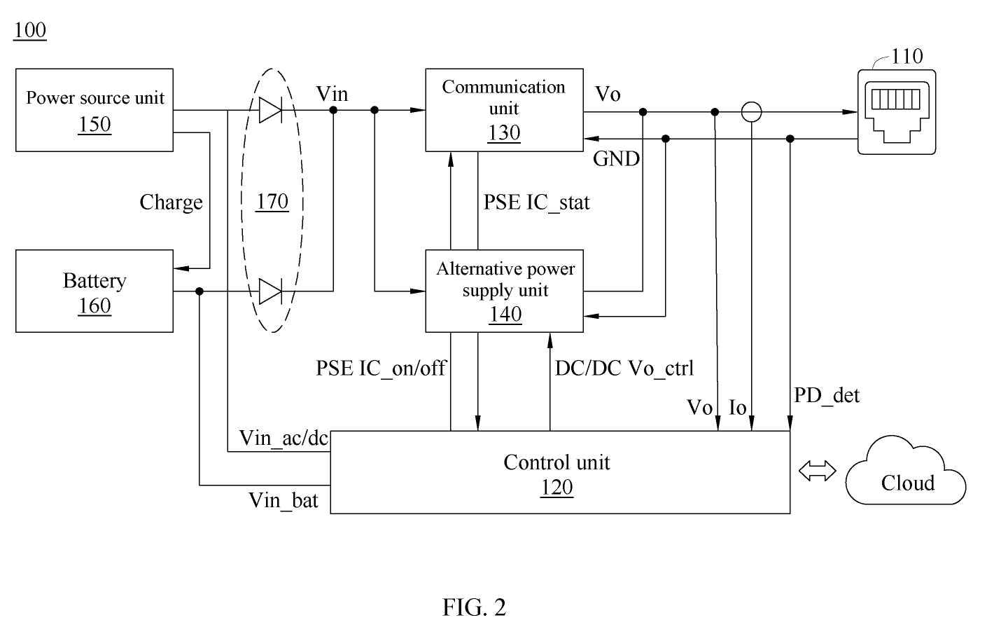

In some embodiments, as shown in FIG. 2, the multimode power supply apparatus 100 may further include a power source unit 150 and a battery 160. The power source unit 150 may be implemented by a switched-mode power supply taking mains power as input. The power source unit 150 and the battery 160 may be parallelly connected through a one-way conduction circuit 170, and may both be electrically coupled to the control unit 120, the communication unit 130 and the alternative power supply unit 140. Under normal condition, the power source unit 150 may also charge the battery 160. Therefore, once the power source unit 150 fails to work properly due to poor contact, mains power outage or other situations, the battery 160 may immediately take over as power supply. The one-way conduction circuit 170 may be implemented by diodes or field effect transistors.

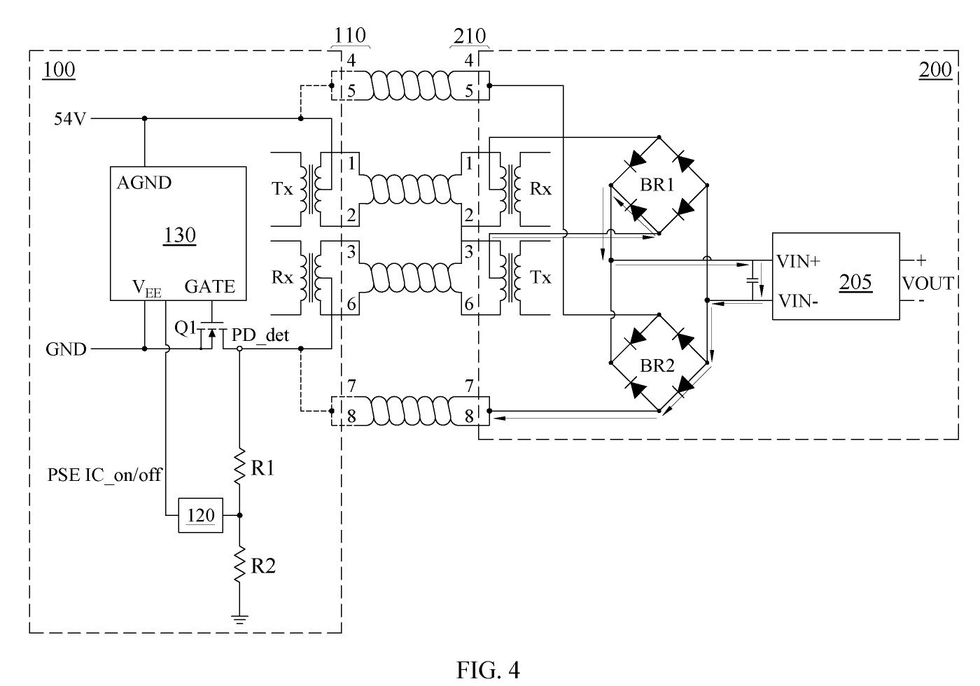

FIG. 4 is a schematic diagram of a multimode power supply apparatus and powered device circuit according to at least one embodiment of the present invention. As shown in FIG. 4, the output connector 110 and an input connector 210 of a powered device 200 (e.g., wireless access point, webcam, VoIP telephone, etc.) may both have interconnected 1&2, 3&6, 4&5 and 7&8 leads, where the 1&2 and 3&6 leads are respectively electrically coupled to a transformer. The powered device 200 may also include a diode bridge BR1, a diode bridge BR2 and a power receiving module 205. If the powered device 200 is not connected to the multimode power supply apparatus 100, the communication unit 130 will not be turned on, and the voltage at the detection node PD_det will be zero. If the powered device 200 is connected to the multimode power supply apparatus 100, an initial voltage from the output connector 110 may be applied to the VIN+ pin of the power receiving module 205 through a transformer tap corresponding to the 3&6 leads and the diode bridge BR1. Then, an input capacitance between the VIN+ pin and the VIN- pin may instantly conduct the initial voltage into the diode bridge BR2. Next, the initial voltage may be received by the output connector 110 in the form of a surge voltage through the 7&8 leads and may finally reach the detection node PD_det. By detecting the surge voltage as described above through, optionally, the voltage dividing resistors R1 and R2, the control unit 120 can detect that the powered device 200 has been connected to the multimode power supply apparatus 100.

In some embodiments, before detecting whether the output connector 110 receives the surge voltage, the control unit 120 may detect whether a first output of the power source unit 150 is within a first normal range, and/or whether a second output of the battery 160 is within a second normal range. The first normal range may be 51.3-56.7 Vdc, the second normal range may be 36-52 Vdc, and the present invention is not limited thereto.

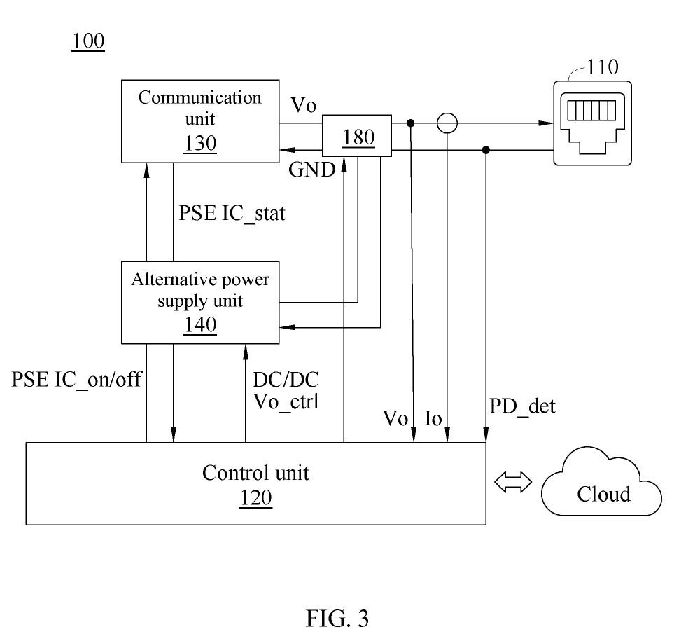

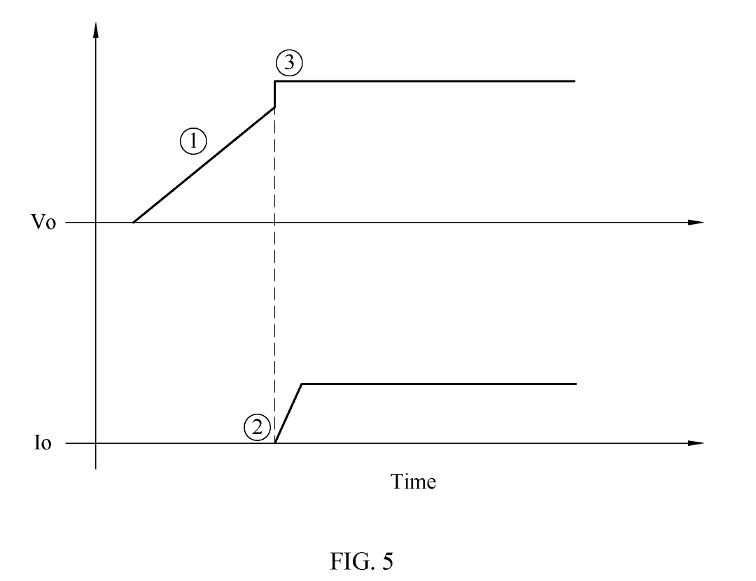

In response to the output connector 110 receiving the surge voltage, the control unit 120 may instruct the communication unit 130 to determine, through the output connector 110, whether the powered device 200 complies with a standard (e.g., IEEE 802.3). The control unit 120 may also instruct the communication unit 130 to determine whether the communication with the powered device 200 is successful. If the communication with the powered device 200 is unsuccessful, a warning may be optionally sent to ensure the safety of both the multimode power supply apparatus 100 and the powered device 200. If the powered device 200 complies with the standard, the communication unit 130 can acquire the rated voltage of the powered device 200 via communication, and the control unit 120 may instruct the communication unit 130 to set the output connector 110 at the rated voltage of the powered device 200, and may monitor the voltage and the current of the output connector 110. If the powered device 200 does not comply with the standard, the communication unit 130 cannot acquire the rated voltage of the powered device 200, and the control unit 120 may turn off the electrical coupling between the communication unit 130 and the output connector 110, and turn on the alternative power supply unit 140 instead. To turn off the electrical coupling between the communication unit 130 and the output connector 110, the communication unit 130 itself may be turned off through a signal wire (e.g., PSE IC_on/off shown in FIGS. 1 and 2), or a switch (e.g., switch 180 shown in FIG. 3). FIG. 5 is a schematic diagram of operation waveform of an alternative power supply unit according to at least one embodiment of the present invention. As shown in FIG. 5, the alternative power supply unit 140 may raise a voltage Vo of the output connector 110 (stage ①) from a default voltage value (e.g., 0 volt) after being turned on. Here, the upper limit for raising the voltage Vo of the output connector 110 may be between 55-60 volts inclusive, preferably 57 volts. When the voltage Vo of the output connector 110 is enough to start the power receiving module 205 of the powered device 200, a current Io of the output connector 110 becomes greater than a threshold current value (e.g., 0 ampere, stage ②). Here, the control unit 120 may record the voltage Vo of the output connector 110 as a starting voltage, and may instruct the alternative power supply unit 140 to set the output connector 110 at the starting voltage multiplied by an operating factor (stage ③) to optimize the operation efficiency of the power receiving module 205, and may monitor the voltage and the current of the output connector 110. The operating factor may be between 1-1.2 inclusive, preferably 1.1.

After instruction for the communication unit 130 or the alternative power supply unit 140 to set the voltage of the output connector 110 has been made, an abnormal condition may occur in the powered device 200 if any one of the following is monitored: (1) the voltage at the output connector 110 has deviated from the set voltage over a threshold time; or (2) the current of the output connector 110 has become less than the threshold current value over a threshold time. As a response, the control unit 120 may turn off the communication unit 130 and the alternative power supply unit 140, send a warning to prompt the user to reconnect the powered device 200 again, and detect whether the output connector 110 has received the surge voltage (i.e., whether the powered device 200 has been reconnected). In an embodiment where the multimode power supply apparatus 100 includes the power source unit 150 and the battery 160, the control unit 120 may detect in advance whether the first output of the power source unit 150 is within the first normal range, and/or whether the second output of the battery 160 is within the second normal range, as described above.

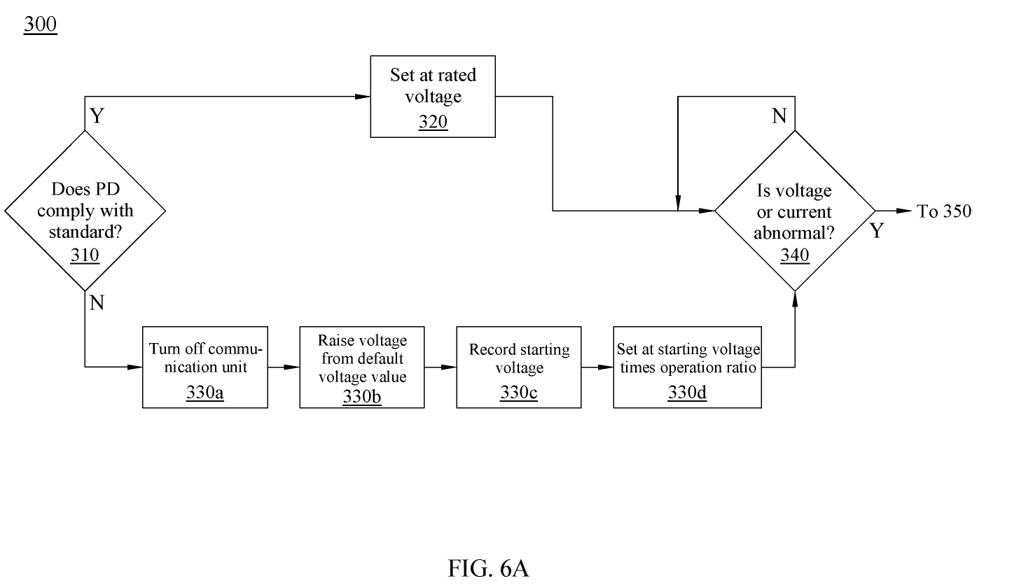

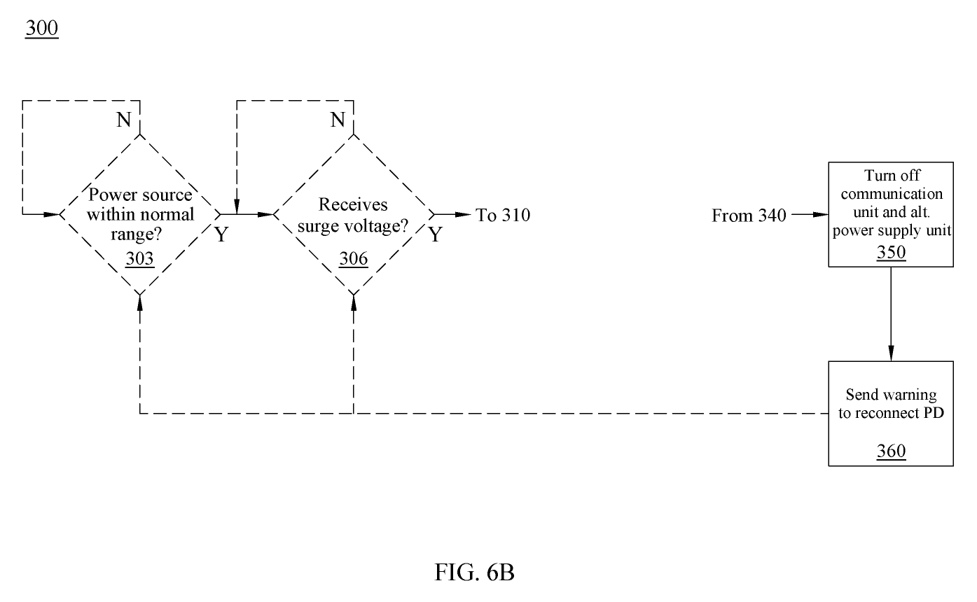

FIGS. 6A and 6B are schematic flowcharts of a multimode power supply method according to at least one embodiment of the present invention. As shown in FIG. 6A, a multimode power supply method 300 may include a step 310 that instructs the communication unit 130 of FIG. 1 to determine, through the output connector 110, whether a powered device complies with a standard (e.g., IEEE 802.3). Here, step 310 may also determine whether communication with the powered device is successful. If the communication with the powered device is unsuccessful, a warning may be optionally sent to ensure the safety of both the power supply apparatus and the powered device. In some embodiments, as shown in FIG. 6B, the multimode power supply method 300 may include a step 306, which is placed before step 310, that detects whether the output connector 110 of FIG. 1 has received the surge voltage. In some embodiments, the multimode power supply method 300 may further include a step 303, which is placed before step 306, that detects whether the first output of the power source unit 150 of FIG. 2 is within the first normal range and/or whether the second output of the battery 160 of FIG. 2 is within the second normal range. The power source unit 150 and/or the battery 160 may be parallelly connected through a one-way conduction circuit 170, and may be electrically coupled to the control unit 120, the communication unit 130 and the alternative power supply unit 140 of FIG. 1. The first normal range may be 51.3-56.7 Vdc, the second normal range may be 36-52 Vdc, and the present invention is not limited thereto.

If the powered device complies with the standard, a step 320 may instruct the communication unit 130 to set the output connector 110 at the rated voltage of the powered device, and then a step 340 may follow to monitor the voltage and the current of the output connector 110. If the powered device does not comply with the standard, a step 330a may turn off the communication unit 130, and a step 330b may turn on the alternative power supply unit 140 of FIG. 1 and instruct the alternative power supply unit 140 to raise the voltage of the output connector 110 from a default voltage value. When the current of the output connector 110 becomes greater than the threshold current value, a step 330c may record the voltage of the output connector 110 as a starting voltage, a step 330d may instruct the alternative power supply unit 140 to set the output connector 110 at the starting voltage multiplied by an operating factor, and then a step 350 may monitor the voltage and the current of the output connector 110. The upper limit for raising the voltage of the output connector 110 may be between 55-60 volts, preferably 57 volts. The operating factor may be between 1-1.2, preferably 1.1.

As shown in FIG. 6B, a step 340 may monitor whether (1) the voltage of the output connector 110 of FIG. 1 has deviated from the set voltage over a threshold time; or (2) the current of the output connector 110 has become less than the threshold current value over a threshold time. If either condition holds (determination result of step 340 is “Y”), a step 350 may turn off the communication unit 130 and the alternative power supply unit 140, then a step 360 may send a warning to reconnect the powered device, and the process may then return to step 306 or step 303.

The present invention has been disclosed as above by the embodiments. However, the embodiments described herein are not intended to limit the present invention. One of ordinary skill in the art can make various changes and modifications without departing from the spirit and scope of the present invention. Accordingly, the scope of the present invention is to be accorded the broadest scope consistent with the appended claims rather than the foregoing description and the exemplary embodiments described therein.

What is claimed is:

1. A multimode power supply apparatus for supplying a powered device, comprising:
an output connector;
a control unit electrically coupled to the output connector;
a communication unit configured to determine, through the output connector, whether the powered device complies with a standard; and
an alternative power supply unit electrically coupled to the output connector,
wherein the control unit is configured to, in response to a determination that the powered device does not comply with the standard, perform the following steps:
turn off an electrical coupling between the communication unit and the output connector;
turn on the alternative power supply unit and instruct the alternative power supply unit to raise a voltage of the output connector from a default voltage value;
when a current of the output connector becomes greater than a threshold current value, record the voltage of the output connector as a starting voltage;
instruct the alternative power supply unit to set the output connector at the starting voltage multiplied by an operating factor; and
monitor the voltage and the current of the output connector.

2. The multimode power supply apparatus of claim 1, wherein the control unit is configured to detect whether the output connector receives a surge voltage, and wherein the communication unit is configured to determine whether the powered device complies with the standard in response to the output connector receiving the surge voltage.

3. The multimode power supply apparatus of claim 1, wherein the control unit is further configured to:
in response to a determination that the powered device complies with the standard, instruct the communication unit to set the output connector at a rated voltage of the powered device;
monitor the voltage and the current of the output connector; and
upload power supply data to the cloud.

4. The multimode power supply apparatus of claim 1, wherein the standard is selected from the IEEE 802.3 standard family.

5. The multimode power supply apparatus of claim 1,
wherein the default voltage value is 0 volt,
wherein the threshold current value is 0 ampere,
wherein an upper limit for the alternative power supply unit to raise the voltage of the output connector from the default voltage value is between 55-60 volts, and
wherein the operating factor is between 1-1.2.

6. The multimode power supply apparatus of claim 1, wherein the alternative power supply unit is a DC conversion unit.

7. The multimode power supply apparatus of claim 2, wherein the control unit is further configured to: in response to any one of the following being monitored: (1) the voltage at the output connector has deviated from the set voltage over a threshold time; or (2) the current of the output connector has become less than the threshold current value over the threshold time, turn off the communication unit and the alternative power supply unit, send a warning to reconnect the powered device, and detect whether the output connector receives the surge voltage.

8. The multimode power supply apparatus of claim 2, wherein the control unit is further configured to:
detect whether a first output of a power source unit is within a first normal range, and/or whether a second output of a battery is within a second normal range; and
in response to the first output being within the first normal range or the second output being within the second normal range, detect whether the output connector receives the surge voltage.

9. The multimode power supply apparatus of claim 8,
wherein the first normal range is 51.3-56.7 Vdc, and the second normal range is 36-52 Vdc, and
wherein the power source unit and/or the battery is electrically coupled to the control unit, the communication unit and the alternative power supply unit through a one-way conduction circuit.

10. The multimode power supply apparatus of claim 8, wherein the control unit is further configured to: in response to any one of the following being monitored: (1) the voltage of the output connector has deviated from the set voltage over a threshold time; or (2) the current of the output connector has become less than the threshold current value over the threshold time, turn off the communication unit and the alternative power supply unit, send a warning to reconnect the powered device, and detect whether the first output is within the first normal range, and/or whether the second output is within the second normal range.

11. A multimode power supply method, comprising:
instructing a communication unit to determine, through an output connector, whether a powered device complies with a standard; and
in response to the powered device not complying with the standard:
turning off an electrical coupling between the communication unit and the output connector;
turning on an alternative power supply unit and instructing the alternative power supply unit to raise a voltage of the output connector from a default voltage value;
when a current of the output connector becomes greater than a threshold current value, recording the voltage of the output connector as a starting voltage;
instructing the alternative power supply unit to set the output connector at the starting voltage times an operation ratio; and
monitoring the voltage and the current of the output connector.

12. The multimode power supply method of claim 11, further comprising:
detecting whether the output connector receives a surge voltage,
wherein the step of determining whether the powered device complies with the standard is performed in response to the output connector receiving the surge voltage.

13. The multimode power supply method of claim 11, further comprising:
in response to the powered device complying with the standard, instructing the communication unit to set the output connector at a rated voltage of the powered device;
monitoring the voltage and the current of the output connector; and
uploading power supply data to the cloud.

14. The multimode power supply method of claim 11, wherein the standard is selected from the IEEE 802.3 standard family.

15. The multimode power supply method of claim 11,
wherein the default voltage value is 0 volt,
wherein the threshold current value is 0 ampere,
wherein an upper limit for the alternative power supply unit to raise the voltage of the output connector from the default voltage value is between 55-60 volts, and
wherein the operation ratio is between 1-1.2.

16. The multimode power supply method of claim 11, wherein the alternative power supply unit is a DC conversion unit.

17. The multimode power supply method of claim 12, further comprising: in response to any one of the following being monitored: (1) the voltage at the output connector has deviated from the set voltage over a threshold time; or (2) the current of the output connector has become less than the threshold current value over the threshold time, turning off the communication unit and the alternative power supply unit, sending a warning to reconnect the powered device, and detecting whether the output connector receives the surge voltage.

18. The multimode power supply method of claim 12, further comprising:
detecting whether a first output of a power source unit is within a first normal range, and/or whether a second output of a battery is within a second normal range; and
in response to the first output being within the first normal range or the second output being within the second normal range, detecting whether the output connector receives the surge voltage.

19. The multimode power supply method of claim 18,
wherein the first normal range is 51.3-56.7 Vdc, and the second normal range is 36-52 Vdc, and
wherein the power source unit and/or the battery is electrically coupled to a control unit, the communication unit and the alternative power supply unit through a one-way conduction circuit.

20. The multimode power supply method of claim 18, further comprising: in response to any one of the following being monitored: (1) the voltage of the output connector has deviated from the set voltage over a threshold time; or (2) the current of the output connector has become less than the threshold current value over the threshold time, turning off the communication unit and the alternative power supply unit, sending a warning to reconnect the powered device, and detecting whether the first output is within the first normal range, and/or whether the second output is within the second normal range.
